(19) United States
(12) Patent Application Publication
(10) Pub. No.: US 2026/0034931 A1
(43) Pub. Date: Feb. 5, 2026

(54) HEADLIGHT WARNING SYSTEM FOR A VEHICLE AND ASSOCIATED METHODS

(71) Applicant: Christopher Harper, Loganville, GA (US)

(72) Inventor: Christopher Harper, Loganville, GA (US)

(21) Appl. No.: 19/276,197

(22) Filed: Jul. 22, 2025

Related U.S. Application Data
(60) Provisional application No. 63/677,432, filed on Jul. 31, 2024.

(51) Int. Cl. B60Q 11/00; B60Q 3/16; B60Q 9/00; H05B 47/11

(52) U.S. Cl. CPC B60Q 11/005; B60Q 3/16; B60Q 9/00; H05B 47/11

(57) ABSTRACT

A headlight warning system for a vehicle includes a logic unit and a warning signal generator. The logic unit receives as inputs a level of ambient light at the vehicle, a position of a headlight switch for headlights of the vehicle, a position of an ignition switch of the vehicle, and a position of doors of the vehicle. The logic unit generates a logic output based on the following detected conditions: the ambient light level is low, the headlight switch is in an off position, the ignition switch is in an on position, and the doors of the vehicle are closed. The warning signal generator generates a warning signal output based on the detected conditions. The warning signal output is to cause a vehicle warning device to generate a warning to alert a driver of the vehicle when the headlights of the vehicle are turned off during nighttime driving.

### CROSS-REFERENCE TO RELATED APPLICATIONS

The present application claims the benefit of U.S. Provisional Patent Application Ser. No. 63/677,432 filed Jul. 31, 2024, all of which is fully incorporated by reference.

### TECHNICAL FIELD

The present disclosure relates to vehicles, and, more particularly, to a headlight warning system to alert a driver of a vehicle that headlights of the vehicle are off during nighttime driving, and associated methods.

### BACKGROUND

Visibility is significantly reduced when driving at nighttime as compared to daytime driving. If auto headlights are not functioning or manually turned off, other drivers might not be able to see such vehicles clearly. This increases the risk of accidents, especially on poorly lit roads.

There are generally two features that many vehicles have that make it more likely for drivers to not realize that their headlights are not on. One of the features is daytime running lamps, and the other feature is highly illuminated dashboards.

Daytime running lamps are automatic exterior lights that switch on whenever the car is running. Although they are not required in the U.S., many other countries, such as Canada, require daytime running lamps on all vehicles. Many American cars are equipped with daytime running lamps as well, and this can create a problem as it begins to get dark while on the road. If a car is not designed to turn on its headlights automatically, the driver might see the light from the daytime running lamps and assume the headlights are on.

Dashboard lights may be on when the headlights are not turned on. Illuminated dashboards generally have bright control lights. This makes it difficult for a driver to recognize when the headlights are not turned on.

Driving at night is more dangerous than driving during daylight hours. Although there are more vehicles on the road during the day, about half of all accidents happen at night, and the occupant fatality rate is about three times higher. Ensuring vehicle headlights are turned on when driving at nighttime is crucial.

### SUMMARY

A headlight warning system for a vehicle includes a logic unit and a warning signal generator. The logic unit receives as inputs a level of ambient light at the vehicle, a position of a headlight switch for headlights of the vehicle, a position of an ignition switch of the vehicle, and a position of doors of the vehicle. The logic unit generates a logic output based on the following detected conditions: the ambient light level is low, the headlight switch is in an off position, the ignition switch is in an on position, and the doors of the vehicle are closed. The warning signal generator generates a warning signal output based on the detected conditions. The warning signal output is to cause a vehicle warning device to generate a warning to alert a driver of the vehicle when the headlights of the vehicle are turned off during nighttime driving.

The logic unit may include a plurality of logic gates coupled together to receive the inputs.

The logic unit, in response to detecting the low ambient light level and the headlight switch being in the off position, does not generate the logic output if the ignition switch is in an off position or if at least one of the doors of the vehicle is in an open position.

The warning signal output warning is for an audible warning and/or a visual warning.

Another aspect is directed to a vehicle that includes the headlight warning system as described above. The vehicle includes a photosensor to detect a level of ambient light at the vehicle, a headlight switch sensor to detect a position of a headlight switch for headlights of the vehicle, an ignition switch sensor to detect a position of an ignition switch of the vehicle, and at least one door switch to detect a position of doors of the vehicle. The headlight warning system is coupled to the photosensor, the headlight switch sensor, the ignition switch sensor and the at least one door switch. The headlight warning system generates a warning signal output based on the following detected conditions: the ambient light level is low, the headlight switch is in an off position, the ignition switch is in an on position, and the doors of the vehicle are closed. The vehicle includes a vehicle warning device coupled to the headlight warning system to generate a warning in response to the generated warning signal output. The warning is to alert a driver of the vehicle when the headlights of the vehicle are turned off during nighttime driving.

Yet another aspect is directed to a method for generating a warning to alert a driver of a vehicle when headlights of the vehicle are turned off during nighttime driving. The method includes detecting a level of ambient light at the vehicle, detecting a position of a headlight switch for the headlights, detecting a position of an ignition switch of the vehicle, and detecting a position of doors of the vehicle. A headlight warning system, in response to the detecting, generates a warning signal output based on the following detected conditions: the ambient light level is low, the headlight switch is in an off position, the ignition switch is in an on position, and the doors of the vehicle are closed. The warning is generated in response to the generated warning signal output.

### BRIEF DESCRIPTION OF THE DRAWINGS

FIG. 1 is a schematic diagram of a vehicle with a headlight warning system in which various aspects of the disclosure may be implemented.

FIG. 2 is a more detailed schematic diagram of the headlight warning system illustrated in FIG. 1.

FIG. 3 is a flowchart for operating the headlight warning system illustrated in FIG. 1.

### DETAILED DESCRIPTION

The present description is made with reference to the accompanying drawings, in which exemplary embodiments are shown. However, many different embodiments may be used, and thus the description should not be construed as limited to the particular embodiments set forth herein. Rather, these embodiments are provided so that this disclosure will be thorough and complete. Like numbers refer to like elements throughout.

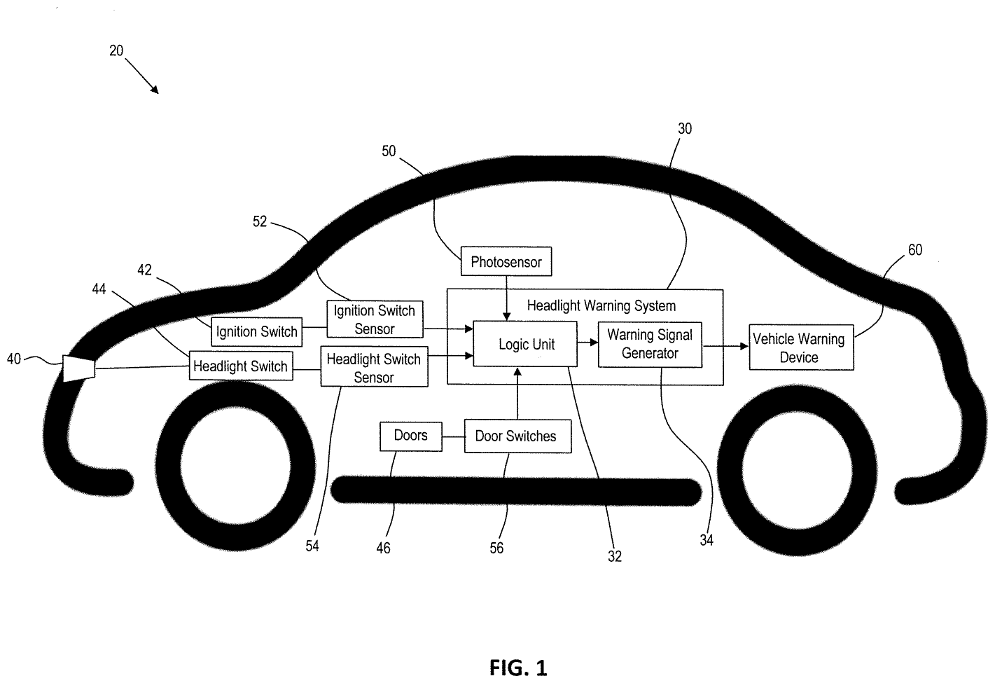

Referring initially to FIG. 1, a vehicle 20 with a headlight warning system 30 will be discussed. The headlight warning system 30 is configured to generate a warning for a driver of the vehicle 20 when the headlights 40 are not turned on during low light level conditions, such as nighttime driving. Driving a vehicle without headlights turned on makes it harder for other drivers to see the vehicle clearly. This increases the risk of accidents, especially on poorly lit roads. The headlight warning system 30 is also configured to determine when the vehicle 30 is being serviced by a mechanic so that a warning is not generated when the headlights 40 are not turned on during low light level conditions.

The headlight warning system 30 is coupled to a photosensor 50 that detects changes in ambient light around the vehicle 30. For newer vehicles, the photosensor 50 may be part of an automatic headlight sensor that turns on the headlights 40 when it gets dark. The automatic headlight sensor includes the photosensor 50 that may be located on the windshield, behind the rearview mirror, or on the dash near the windshield edge. For vehicles that do not include an automatic headlight sensor, the photosensor 50 is installed on the vehicle 20 for the headlight warning system 30.

A number of conditions need to exist before a warning is given to the driver in response to the photosensor 50 detecting low light level conditions. A first condition is for the headlight switch 44 to be in the off position. This condition may be detected by a headlight switch sensor 54 that interfaces between the headlight switch 44 and the headlight warning system 30. The headlight switch sensor 54 provides an output when the headlight switch 44 is in the off position. This output is received by the headlight warning system 30.

A second condition is for the ignition switch 42 to be in the on position, indicating that the ignition system of the vehicle 20 is operating. The vehicle 20 may be started using a keyless ignition system or a traditional ignition system.

For a vehicle 20 with a keyless ignition system, electronic authentication is used to start the vehicle without the traditional metal key. Instead, the driver carries a small plastic device called a key FOB that sends a radio signal to the vehicle's computer when the key FOB is within range. The driver can then start the vehicle 20 by pressing a button or turning a switch. The button or switch corresponds to the ignition switch 42.

For a vehicle that uses a metal key to start the vehicle 20, the ignition switch 42 has an on position and a start position. After the ignition switch 42 has been moved to the start position to start the vehicle 20, the ignition switch 42 returns to the on position.

An ignition switch sensor 52 interfaces between the ignition switch 42 and the headlight warning system 30 to determine that the ignition switch 42 is in the on position. Alternatively, the ignition switch sensor 52 may tap into a fuse that is only live when the vehicle 20 is running. The ignition switch sensor 52 provides an output when the ignition switch 42 is in the on position. This output is received by the headlight warning system 30.

A third condition is for the doors 46 of the vehicle 20 to be closed. In some embodiments, the third condition is met when the driver's door 46 is closed. Each door 46 typically has a door jamb switch 56 associated therewith. A vehicle' door jamb is the area where the door 46 connects to the vehicle's body. This condition may be detected by tapping into the door jamb switch 56. The door switch 56 provides an output when one or more doors 46 of the vehicle 20 are in an on position. This output is received by the headlight warning system 30. As an alternative to a door jamb switch 56, a door sensor may be used.

The headlight warning system 30 includes a logic unit 32 and a warning signal generator 34. The logic unit 32 and the warning signal generator 34 are connected to a power source 80. The logic unit 32 is configured to operate when the photosensor 50 detects low ambient light conditions. In response to the photosensor 50 detecting low ambient level conditions, the logic unit 32 is to perform logical operations for the vehicle 20 to determine if the above described first, second and third conditions are met.

If the first, second and third conditions are met, then the logic unit 32 generates a logic output to the warning signal generator 34. The warning signal generator 34 generates a warning signal output that is applied to a vehicle warning device 60. The vehicle warning device 60 may be audible device and/or a visual device.

When the audible device is a speaker, then the warning signal output is an audio signal for the speaker. The audio signal may generate a beeping noise similar to a seat belt warning chime that reminds the driver to use the seat belt while seated in a moving car.

When the visual device is a light or display, then the warning signal output is an electrical signal that may be used to activate the light and/or the display. The light and the display may be on a dashboard of the vehicle. Alternatively, the dashboard lights may be turned off to get the driver's attention that the headlights 40 are not turned on.

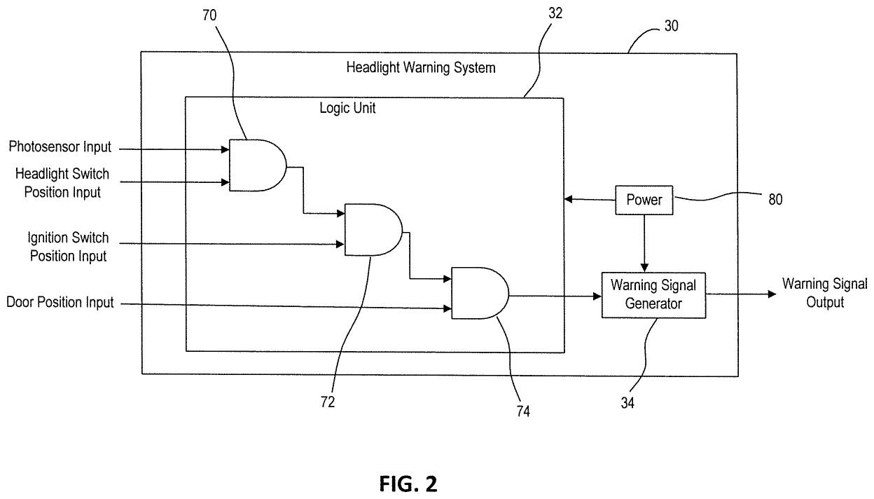

An example embodiment of the logic unit 32 will now be discussed in reference to FIG. 2. The logic unit 32 includes a plurality of interconnected logic gates 70, 72 and 74. The illustrated logic gates 70, 72 and 74 are AND gates. In other embodiments, the logic unit 32 may be configured with other type logic gates.

An AND gate is a basic digital logic gate that implements a logical operation in response to two operands being applied as inputs. The AND gate generates a true output if and only if both of the operands are true. If one or both of the operands are false, then the AND gate generates a false output.

The first AND gate 70 receives as input the ambient light level from the photosensor 50, and a position of the headlight switch 44. If the ambient light level is low and the headlight switch 44 is in the off position, then a true output is generated by the first AND gate 70.

The second AND gate 72 receives as input the true output from the first AND gate 70 and a position of the ignition switch 44. If the ignition switch 44 is in the on position, then a true output is generated by the second AND gate 72.

The third AND gate 74 receives as input the true output from the second AND gate 72 and a position of one or more doors 46 of the vehicle 20. If the doors 46 are closed, then a true output is generated by the third AND gate 74. The true output from the third AND gate 74 may also be referred to as a logic output of the logic unit 32.

The warning signal generator 34 receives as input the logic output from the logic unit 32, and in response, generates at least one warning signal output. When the vehicle warning device 60 is a speaker, then the warning signal output is an audio signal for the speaker. When the vehicle warning device 60 is a light or display, then the warning signal output is an electrical signal that may be used to active the light and/or the display. The light and the display may be on a dashboard of the vehicle. Alternatively, the dashboard lights may be turned off or on/off to get the driver's attention that the headlights 40 are not turned on.

The headlight warning system 30 may be included in newly manufactured vehicles, or may be added to existing vehicles as a retrofit kit. Newly manufactured vehicles typically include a controller area network (CAN) bus and electronic control units (ECUs). The CAN bus is a message-based protocol designed to allow the electronic control units (ECUs) to communicate with each other.

The headlight warning system 30 may be integrated with the CAN bus to receive the necessary sensor inputs if they are available over the CAN bus. For example, the CAN bus transmits a start signal from the ignition switch to the vehicle's fuse panel, which is then used to control the starter motor relay. The start signal would also be transmitted to the headlight warning system 30 as an input. Likewise, the CAN bus can communicate to the headlight warning system 30 that a vehicle door is open. The logic unit 32 in the headlight warning system 30 would be configured to receive the applicable messages via the CAN bus, with the applicable messages then being adapted as logic inputs for one or more of the logic gates 70, 72, 74.

As a retrofit kit, the headlight warning system 30 includes harnesses and the necessary sensors if the vehicle being retrofitted does not include such sensors. For each sensor that is already provided on the vehicle, then the harness would tap into the existing sensor. In other embodiments, the harnesses may tap into the CAN bus to receive the necessary inputs.

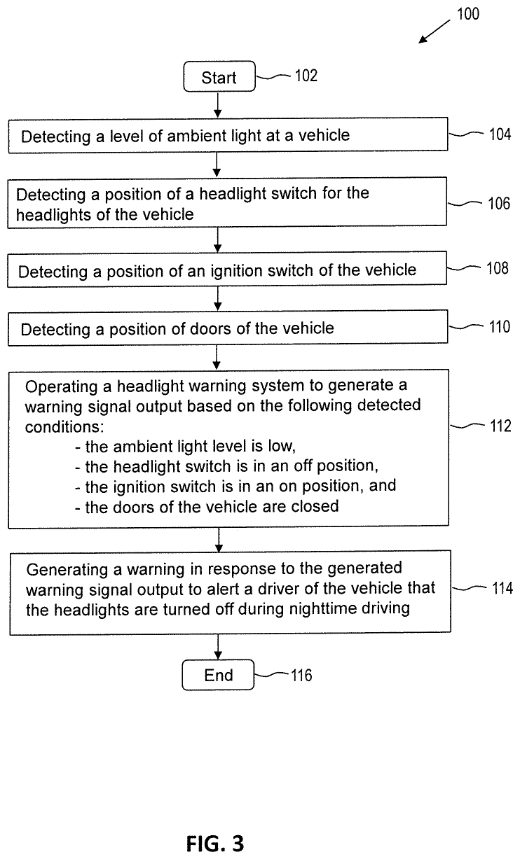

Another aspect is directed to a method for operating the headlight warning system 30 within a vehicle 20 as discussed above. Referring now to the flowchart 100 in FIG. 3, from the start (Block 102), the method includes detecting a level of ambient light at the vehicle 20 at Block 104. The method further includes detecting a position of the headlight switch 44 for the headlights 40 at Block 106, detecting a position of the ignition switch 42 at Block 108, and detecting a position of doors 46 of the vehicle 20 at Block 110.

The headlight warning system 30 is operated at Block 112, and in response to the detecting, generates a warning signal output based on the following detected conditions: the ambient light level is low, the headlight switch 44 is in an off position, the ignition switch 42 is in an on position, and the doors 46 are closed. A warning is generated in response to the generated warning signal output to alert a driver of the vehicle 20 that the headlights 40 of the vehicle 20 are turned off during nighttime driving. The method ends at Block 116.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

1. A headlight warning system for a vehicle comprising:
a logic unit configured to receive the following inputs:
a level of ambient light at the vehicle,
a position of a headlight switch for headlights of the vehicle,
a position of an ignition switch of the vehicle, and
a position of doors of the vehicle,
the logic unit configured to generate a logic output based on the following detected conditions:
the ambient light level is low,
the headlight switch is in an off position,
the ignition switch is in an on position, and
the doors of the vehicle are closed; and
a warning signal generator coupled to the logic unit and configured to generate a warning signal output based on the detected conditions, with the warning signal output to cause a vehicle warning device to generate a warning to alert a driver of the vehicle when the headlights of the vehicle are turned off during nighttime driving.

2. The headlight warning system according to claim 1 wherein the logic unit comprises a plurality of logic gates coupled together to receive the inputs.

3. The headlight warning system according to claim 1 wherein the logic unit, in response to detecting the low ambient light level and the headlight switch being in the off position, does not generate the logic output if the ignition switch is in an off position or if at least one of the doors of the vehicle is in an open position.

4. The headlight warning system according to claim 1 wherein the warning signal output warning is for an audible warning.

5. The headlight warning system according to claim 1 wherein the warning signal output is for a visual warning.

6. A vehicle comprising:
a photosensor to detect a level of ambient light at the vehicle;
a headlight switch sensor to detect a position of a headlight switch for headlights of the vehicle;
an ignition switch sensor to detect a position of an ignition switch of the vehicle;
at least one door switch to detect a position of doors of the vehicle;
a headlight warning system coupled to the photosensor, the headlight switch sensor, the ignition switch sensor and the at least one door switch, with the headlight warning system configured to generate a warning signal output based on the following detected conditions:
the ambient light level is low,
the headlight switch is in an off position,
the ignition switch is in an on position, and
the doors of the vehicle are closed; and
a vehicle warning device coupled to the headlight warning system and configured to generate a warning in response to the generated warning signal output, with the warning to alert a driver of the vehicle when the headlights of the vehicle are turned off during nighttime driving.

7. The vehicle according to claim 6 wherein the headlight warning system comprises:
a logic unit configured to receive inputs from the photosensor, the headlight switch sensor, the ignition switch sensor and the at least one door switch, with the logic unit to generate a logic output in response to the detected conditions; and
a warning signal generator configured to generate the warning signal output based on the generated logic output.

8. The vehicle according to claim 7 wherein the logic unit comprises a plurality of logic gates coupled together to receive the inputs.

9. The vehicle according to claim 7 wherein the headlight warning system, in response to detecting the low ambient light level and the headlight switch being in the off position, does not generate the warning signal output if the ignition switch is in an off position or if at least one of the doors of the vehicle is in an open position.

10. The vehicle according to claim 7 wherein the warning is an audible warning.

11. The vehicle according to claim 7 wherein the warning is a visual warning.

12. The vehicle according to claim 7 comprises dashboard lights, and wherein the warning causes the dashboard lights to turn off.

13. A method for generating a warning to alert a driver of a vehicle when headlights of the vehicle are turned off during nighttime driving, the method comprising:
detecting a level of ambient light at the vehicle;
detecting a position of a headlight switch for the headlights;
detecting a position of an ignition switch of the vehicle;
detecting a position of doors of the vehicle;
operating a headlight warning system, in response to the detecting, to generate a warning signal output based on the following detected conditions:
the ambient light level is low,
the headlight switch is in an off position,
the ignition switch is in an on position, and
the doors of the vehicle are closed; and
generating the warning in response to the generated warning signal output.

14. The method according to claim 13 wherein the headlight warning system, in response to detecting the low ambient light level and the headlight switch being in the off position, does not generate the warning signal output if the ignition switch is in an off position or if at least one of the doors of the vehicle is in an open position.

15. The method according to claim 13 wherein the warning is an audible warning.

16. The method according to claim 13 wherein the warning is a visual warning.

17. The method according to claim 13 wherein the warning is to cause dashboard lights of the vehicle to turn off.

18. The method according to claim 13 wherein detecting the level of ambient light is performed using a photosensor.
